(19) United States
(12) Patent Application Publication
(10) Pub. No.: US 2007/0168464 A1
(43) Pub. Date: Jul. 19, 2007

(54) System for Configuring a Data Exchange and Format Conversion System

(75) Inventors: Julianne Noonan, Boyertown, PA (US); David Brook Yantis, West Chester, PA (US); Clyde S. Harmes IV, Morgantown, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/610,137

(22) Filed: Dec. 13, 2006

Related U.S. Application Data
(60) Provisional application No. 60/749,989, filed on Dec. 13, 2005.

(51) Int. Cl. G06F 15/16

(52) U.S. Cl. 709/218

(57) ABSTRACT

A system automatically configures a data exchange system used for exchanging data between different computer systems using different data formats. The system includes an input processor for receiving an input message having a first data format employed by a particular message source and a configuration processor. The configuration processor parses and interprets the input message to identify characteristics including individual data fields and updates stored data conversion information for use in converting data from the particular message source having the first data format to a desired output format used by a target destination system, in response to the identified characteristics.

The present patent application derives priority from U.S. Provisional Patent Application Ser. No. 60/749,989 by J. Noonan et al. filed Dec. 13, 2005.

### FIELD OF THE INVENTION

The present invention relates generally to the field of data processing, and more specifically to a system for controlling an integration system that communicates data between systems that utilize different data formats.

### BACKGROUND OF THE INVENTION

Interface engines exist and are used in computer systems to allow data to be exchanged between different computer systems that use different data formats. Existing interface engines include a set of definitions that are used to process and format the received data to be output to a destination system. When a change is made to data on a first (originating) system, a user needs to manually modify the integration engine definitions in order for a second (destination) system to be able to utilize and/or recognize the changed data. For example, if the originating system is collecting an additional piece of information that was previously uncollected, the integration engine definition needs to be manually updated so that the engine recognizes this newly collected piece of data. Alternatively, if the originating system interfaces are point-point, the custom interface code needs to be manually modified.

Existing integration systems require manual intervention by someone with required skills to make interface definition changes. For a system that allows dynamic updates to definitions this could mean that changes to data being sent are made before changes to the interface definition that handles them can be made. A need exists for a system that dynamically and automatically updates definitions used by an integration engine to allow changes made to data in one system to be formatted and used by a second system. A system according to invention principles addresses these deficiencies and associated problems

### BRIEF SUMMARY OF THE INVENTION

In accordance with principles of the present invention, a system automatically configures a data exchange system used for exchanging data between different computer systems using different data formats. The system includes an input processor for receiving an input message having a first data format employed by a particular message source and a configuration processor. The configuration processor parses and interprets the input message to identify characteristics including individual data fields. The configuration processor updates stored data conversion information for use in converting data from the particular message source having the first data format to a desired output format used by a target destination system in response to the identified characteristics.

In accordance with another aspect of the present invention, the configuration processor parses and interprets the input message to identify characteristics including individual data fields and creates stored data conversion information for use in converting data from the particular message source having the first data format to a desired output format used by a target destination system, in response to the identified characteristics.

A further aspect of the present invention includes the configuration processor parses and interprets the input message to identify characteristics including individual data fields and deletes stored data conversion information previously used in converting data from the particular message source having the first data format to a desired output format used by a target destination system, in response to the identified characteristics.

### BRIEF DESCRIPTION OF THE DRAWING

FIG. 1 is a block diagram of the system for configuring a data exchange and format conversion system according to invention principles;

FIG. 2 is a block diagram of a system able to create a schema for use with the system shown in FIG. 1 according to invention principles;

FIG. 3 is a flow diagram detailing the data differentiation made by the integration engine according to invention principles;

FIG. 4 is a flow diagram detailing the automatic creation of a transaction definition in an integration engine according to invention principles;

FIGS. 5A-5B are flow diagram detailing the automatic updating of an existing transaction definition in an integration engine according to invention principles;

FIGS. 6A-6B are flow diagram detailing the automatic deletion of an existing transaction definition in an integration engine according to invention principles;

FIG. 7 is flow diagram detailing operation of the integration engine after being successfully updated according to invention principles;

FIG. 8 is an exemplary display image of a user interface for creating a schema used to update an integration engine according to invention principles;

FIG. 9 is XML code representing an exemplary schema created by the user interface in FIG. 6 according to invention principles;

FIG. 10 is an exemplary display image of a set of transaction definitions that are updated by the schema shown in FIG. 7 according to invention principles; and

FIG. 11 is a flow diagram detailing operation of the data exchange and format conversion system according to invention principles.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, software development planning and management system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

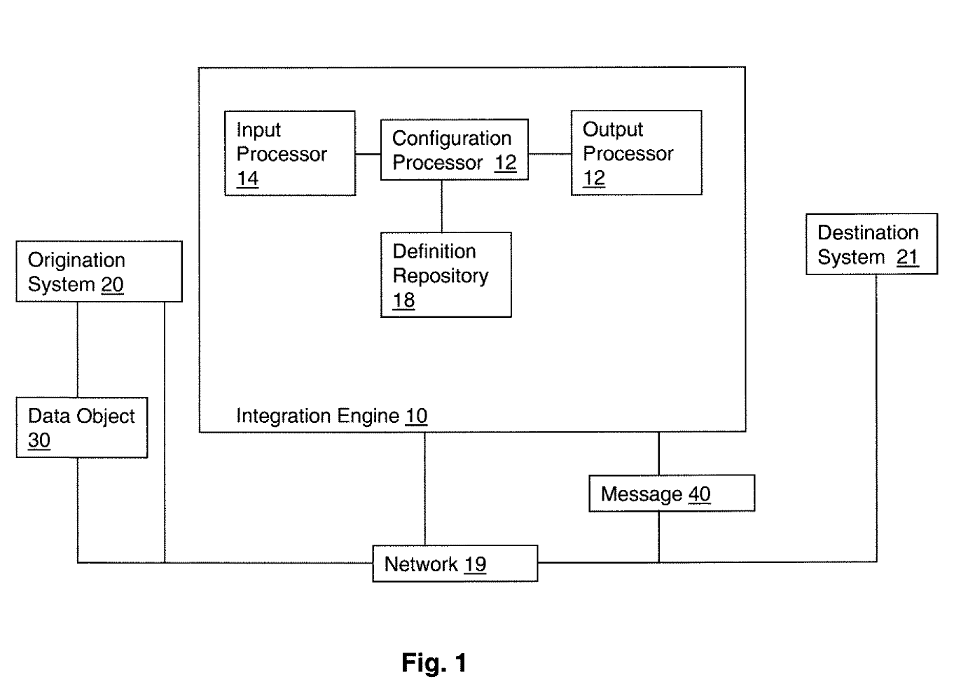

A user interface (UT), as used herein, comprises one or more display images, generated by the display processor under the control of the processor. The UI also includes an executable procedure or executable application. The executable procedure or executable application conditions the display processor to generate signals representing the UT display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UT display images in response to the signals received from the input devices. In this way, the user interacts with the display image using the input devices, enabling user interaction with the processor or other device. The steps and functions performed by the systems and processes of FIGS. 1-11 may be performed wholly or partially automatically or in response to user command.

Data exchange and translation systems may be connected between multiple different computer systems wherein each respective system may collect, receive or obtain data in a different format from one or more of the other computer systems connected thereto. Often one of the multiple different systems uses a first data format to collect a first set or type of data and needs to communicate that first set/type of data in the first format to a different second system that processes data in a different second data format. Data exchange and translation system (integration engine 10) facilitates this process. Integration engine 10 includes at least one set of transaction definitions associated therewith that facilitates the conversion of data type and/or format between systems. The set of definitions may be an electronic file stored in a repository and encoded in any programming language recognized by the data exchange and conversion system. For example, the definitions may be encoded in XML or any other markup language which provides programming flexibility. Each instance of data conversion made by the integration engine is referred to as a transaction and is controlled directly by the set of transaction definitions. Specifically, for each transaction in the set of transaction definitions, an Event Path Table (EPT) is defined and controls when information is exchanged (event) and the route (source and destination points) that is used between two or more applications or systems. Additionally, the EPT defines if any mapping is required between multiple different systems.

The system uses data fields (e.g. XML tags within the data object) as the node names in the transaction definition. Output transaction configuration may require manual user intervention at the originating system to effect proper data routing. The user at the originating system may map the data from the source format to the destination format. Mapping source data to destination data is accomplished by opening the source transaction definition and the destination transaction definition and manually selecting the source node, the destination node and activating a “MAP” function. This results in identifying where source data is to be placed on a destination record during data exchange and format conversion. This manual selection process creates a relationship between the data on the source transaction with the data on the destination transaction. The user may further select source transaction data elements that are related to any destination transaction data elements. The data relationships between a specific source transaction and a specific destination transaction are stored in the integration engine 10 as a map definition and are used in conjunction with the transaction definition to facilitate data exchange and conversion. This map definition is a collection of one or more relationships, each of which relates data from a specific inbound source transaction to data for a specific outbound destination transaction. These relationships also contain user supplied settings and options that govern the rules, formatting and transformations as the data moves from the source transaction to the destination transaction. A specific inbound source transaction can be related to multiple outbound destination transactions by creating a map definition for each of the pairs of source and destination transactions. In this way, it is possible for a single inbound source transaction to be transformed into multiple different outbound destination transactions.

Integration engine 10 (FIG. 1) recognizes and differentiates between application data and a schema or XML definition that may be created by a first system. The schema or XML definition may include an update to a set of transaction definitions in the integration engine. The schema or XML definition created by the first system may be provided in response to a user command or automatically in response to a system operation and/or rule associated with the data being processed, captured or collected by the first system. This advantageously enables the integration engine 10 to dynamically create/modify or delete transaction definitions in the integration engine allowing for further automation of creation of interfaces useable by other systems. Integration engine 10 eliminates the need to manually modify an interface and transaction definition when a change is made to the data being sent from an originating system. It allows for quicker modifications to definitions without user intervention. This reduces or eliminates any need for downtime to make such modifications. Additionally, the system enables modifications to the transaction definitions to be performed automatically and dynamically without interface development resource intervention.

Automatic and dynamic updates to transaction definitions enable substantially immediate recognition of changes to data being sent between one or more computer systems. Clinical Information Systems allows users to make system changes to capture and transmit different data elements. Once a change is made and saved it is necessary to make changes to the integration engine (interface) to recognize that new or different data elements are being sent. Integration engine 10 enables the change to be sent and to automatically make those changes to the interface definitions.

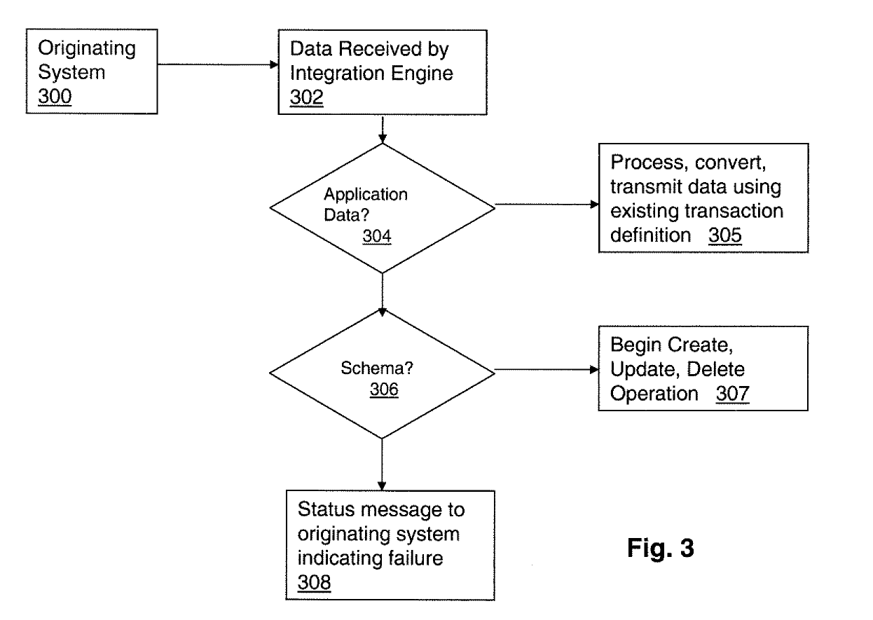

A system for controlling data exchange and format conversion is shown in FIG. 1. Integration engine 10 facilitates communication and data transmission between an originating system 20 and a destination system 21 connected to one another by communications network 19. Integration engine 10 may he resident on a server or any computer system able to host an executable application that facilitates data transmission and format conversion between systems. Integration engine 10 includes definition repository 18 that stores least one transaction definition. A transaction definition provides rules and/or instructions on how to process data transactions between originating system 20 and the destination system 21. A configuration processor 12 is connected to the definition repository 18 and between an input processor 14 and an output processor 16. The input processor 14 selectively receives a data object 30 from the originating system 20. The data object 30 may be a file encoded in, for example, XML or other markup language or a message generated by originating system 20 including encoded data as a an associated file. The data object 30 includes at least one schema or application data. A schema as used hereinafter is a set of parameters indicating the organization and/or structure of a transaction to be performed by integration engine 10. The schema may be an encoded XML file that governs an XML transaction between different computer systems. However, the schema is not limited to XML encoding and may be encoded in any language, markup (e.g., SGML, HTML) or otherwise, that is used by a data exchange and format conversion system. The schema is created at the originating system 20, for example, in response to user comniand as a result of data modeling. The originating system 20 provides the users the ability to define a data model to store application data which is used by at least one respective application resident on the originating system 20. The data model describes the structure of the information contained within a domain. This data model can be encoded using XML or any language, markup or otherwise. This representation is transmitted to the integration engine 10 and causes a transaction to be created or updated. The term application data as used herein is information captured, created, collected, parsed or received by a computer system that is formatted to conform to a schema and which may be transmitted to the destination system 21. Integration engine 10 advantageously and automatically determines whether the data object 30 is a schema or application data using the process discussed later in connection with FIG. 3 and automatically processes the data object 30 in response to the determination. With respect to application data, the configuration processor 12 processes the application data in response to one or more transaction definitions in the definition repository 18 and causes the processed application data to be transmitted to the destination system 21 via the output processor 16. Data format conversion of application data in response to transaction definitions may be performed in a variety of ways as known.

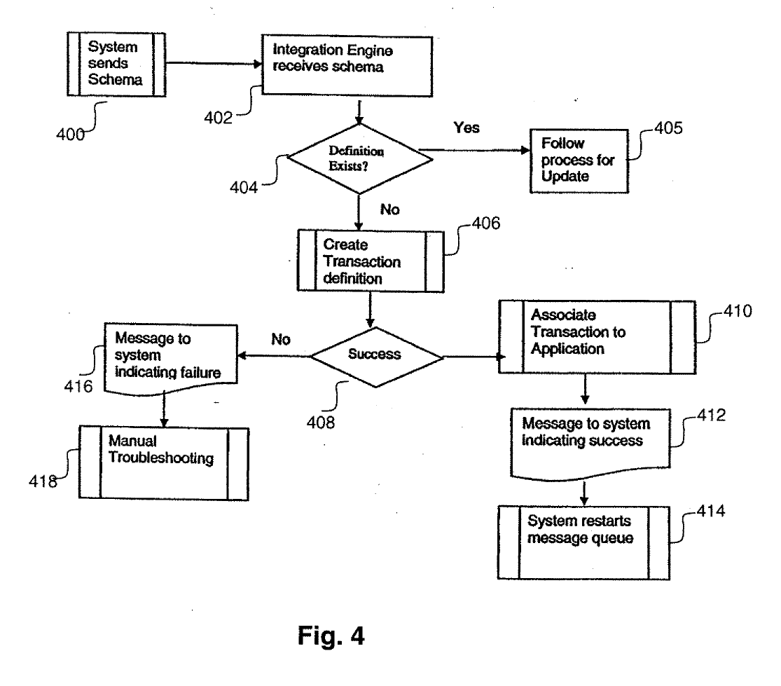

Upon receiving at least one schema, configuration processor 12 executes an application which parses the received schema and the transaction definitions received from definition repository 18 to perform predetermined functions. Configuration processor 12 creates a log of the schema received and used to modify the transaction definition. The log records the status of any modification to a transaction definition including success and/or failure of the modification and reasons why the modification succeeded or failed. As is discussed later with respect to FIGS. 4-7, in response to this parsing, configuration processor 12 executes an application that at least one of creates, updates and deletes a transaction of the stored transaction definition(s). Configuration processor 12 further executes an application able to check the validity of the performed predetermined function and generate a status message 40 identifying success or failure of function performance. Status message 40 may be transmitted for receipt by originating system 20 to notify a user that the transaction definition was modified in accordance with the instructions in the schema. While the status message generation function of the present system is described as being performed by configuration processor 12, it should be noted that the described functionality may be performed by a separate message processor (not shown) that is in communication with any or each processor component (12, 14, 18) and definition repository 16.

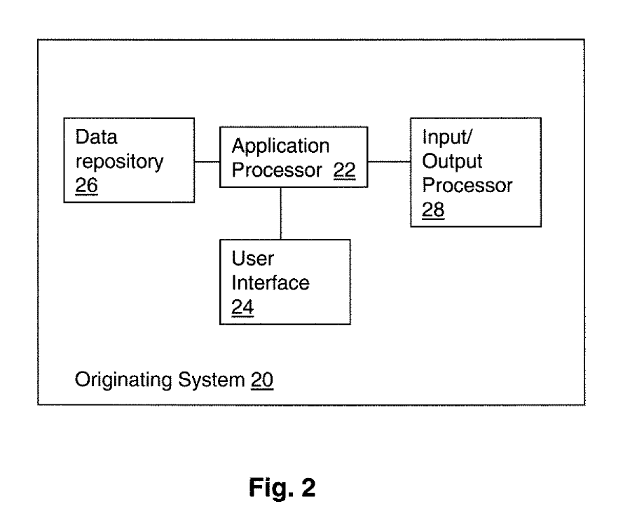

FIG. 2 is a block diagram of originating system 20 as shown in FIG. 1. Originating system 20 at least one of creates, acquires, allocates, captures, collects and logs data for at least one executable application. An application processor 22 controls the operation of the originating system and includes machine readable and executable code that performs the predetermined functions of the system. The application data may be stored within a data repository 26 for later use. For example, the originating system may be a Clinical Information System that collects and organizes medical and/or healthcare-related data for a predetermined purpose. Originating system 20 includes a user interface 24 which is in communication with application processor 22 and allows for user control of the functions performed by the application processor 22. A user of originating system 20 may require a change in the data being collected and, in response to this change, creates a new schema to handle this additional (or changed) data.

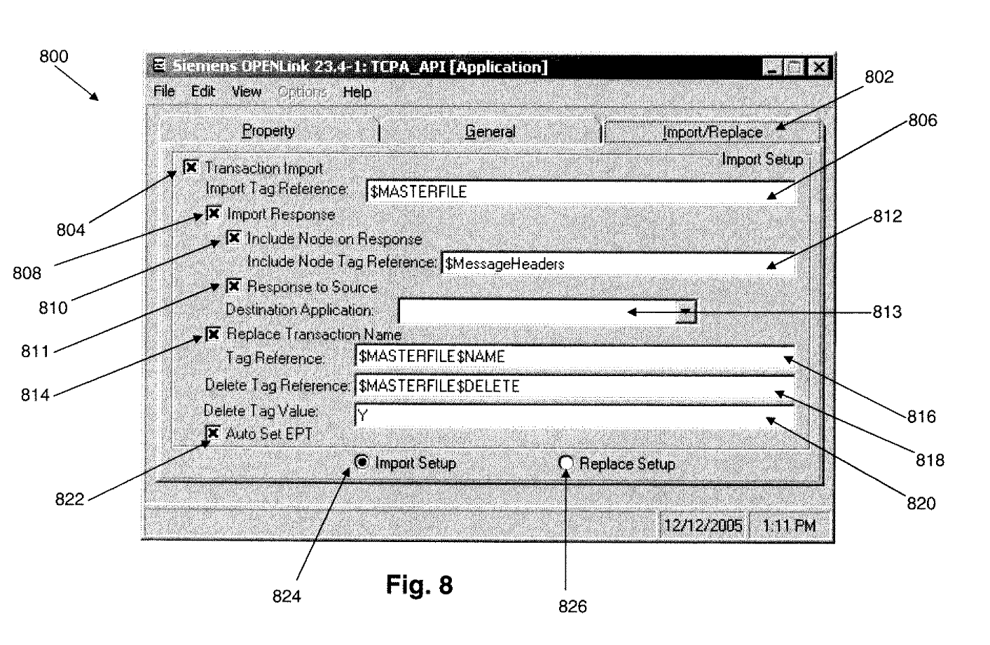

Integration engine 10 advantageously configures the data exchange system automatically in response to the schema created by the user via the user interface 24. An exemplary display image of user interface 24 for creating a schema is shown in FIG. 8. When configuring the schema, the user at originating system 20 employs an application (source from which data is received from and not shown). User interface 24 enables a user of originating system 20 to configure the ability of originating system 20 to send a configuration message(s) comprising user-configured schema, including the created schema, that are to be used to create internal transaction definitions within integration engine 10 (FIG. 1). The user-configured schema further specifies how integration engine 10 differentiates between a schema to be used in creation of a transaction definition and application data that is to be parsed and transmitted to destination system 21.

Originating system 20 further includes an input/output processor 28 for selectively receiving and transmitting the data object 30 (FIG. 1) including data representing at least one of a schema and application data. System 20 communicates data object 30 to engine 10 via network 19 (FIG. 1) preferably adapted to use one or more data formats, otherwise called protocols, depending on the type and/or configuration of the various elements in system 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol, HTTP and HTTPS. Network communication paths may be formed as a wired or wireless (W/WL) connection. The wireless connection permits a person using system 10 to be mobile beyond the distance permitted with a wired connection.

FIG. 3 describes how the system as shown in FIG. 1 advantageously automatically recognizes and distinguishes between application data and schema. At step 300, originating system 20 (FIG. 1) selectively transmits a data object 30 including at least one schema or application data to integration engine 10.

Integration engine 10 receives a data object which is one of schema or application data in step 302. Integration engine 10 selectively determines if the received data object is application data at step 304. integration engine 10 parses the data object 30 to determine if the data object 30 includes data corresponding to an existing schema. If the result of this determination is positive, data object 30 is identified as application data and the application data is processed at step 305 in accordance with the existing transaction definition (including any format conversions needed) and communicated to destination system 21 (FIG. 1). If the determination at step 304 is negative, integration engine 10 checks, at step 306, if the data object 30 is a schema intended to create, modify or delete an existing transaction definition stored in definition repository 18 of integration on engine 10.

The determination made at step 306 is controlled by the schema which is received by integration engine 10 from originating system 20. Integration engine 10 parses the data object 30 for a transaction import tag signifying an update to the existing transaction definitions is to occur and/or an encoded tag identifying data object 30 as schema. The Transaction Import Tag field on the application definition associated with the application processor 22 (FIG. 2) of originating system 20 is used to indicate data object 30 is a schema. Integration engine 10 parses and examines predetermined nodes of transactions of the schema to identify a transaction import tag. Additionally or alternatively, engine 10 searches data object 30 for application data conforming to an existing transaction definition. If no application data payload is found, the object may also be identified as a schema and treated as such.

If a schema is detected at step 306, the schema is processed and the modification of the transaction definition in response to the parameters encoded within the schema proceeds at step 307. This modification may include any of creation of a new transaction definition, updating an existing transaction definition and deleting an existing transaction definition. Once modified, configuration processor 12 (FIG. 1) causes the modified transaction definition to be loaded and activated so that further data objects 30 including application data payloads are processed using the modified transaction definition. If integration engine 10 is unable to label the data object as either application data or a schema, a message is generated and communicated back to the originating system indicating a failure (step 308).

FIGS. 4-7 detail the plurality of modifications able to be made to a transaction definition stored in definition repository 18 of integration engine 10 as shown in FIG. 1. The discussion of FIGS. 4-7 is treated as though the integration engine 10 has selectively determined that the data object received thereby is a schema in the manner discussed above with respect to FIG. 3. The modifications include creating a new transaction within the transaction definition to allow exchange and conversion of data previously not accounted for, updating an existing transaction within the transaction definition; and/or deleting an existing transaction within the transaction definition. These modifications may occur at any level within the transaction definition including but not limited to the node, child, grandchild levels, attributes and CDATA (character data that is not to be parsed by an XML processor). Once the modifications, as dictated by the received schema, are made, configuration processor 12 (FIG. 1) of the integration engine causes the new modified transaction definition to be loaded and activated to allow processing of subsequently received application data.

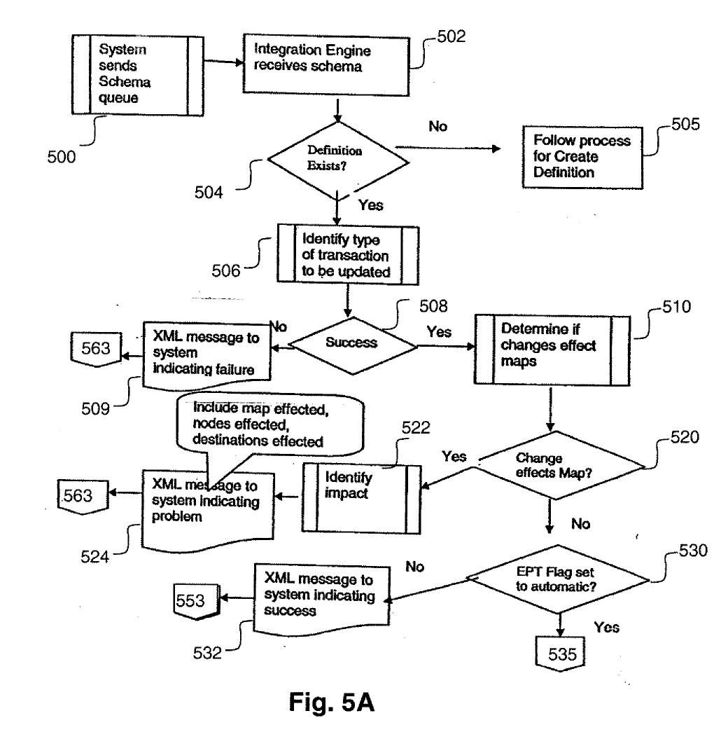

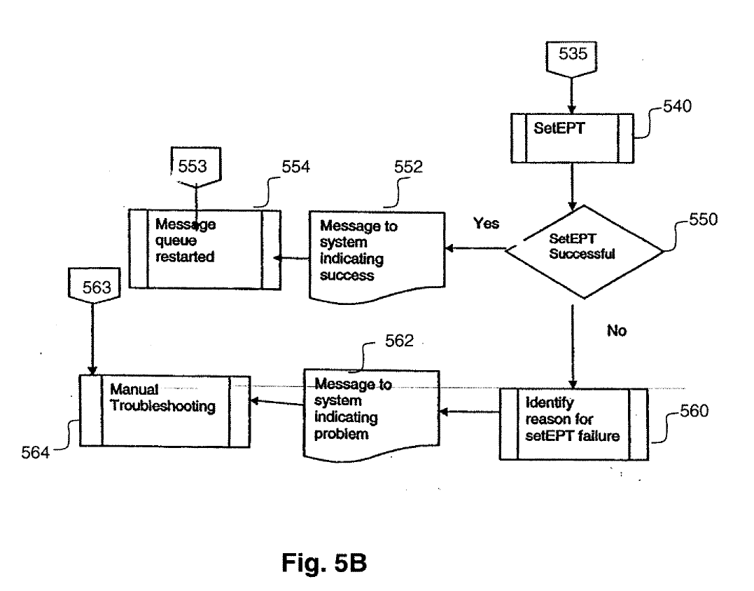

FIG. 4 shows the process by which the system as shown in FIG. 1 modifies a transaction definition by creating a new transaction. Originating system 20 (FIG. 1) sends a schema at 400 and the input processor 14 (FIG. 1) receives the schema at 402. The received schema is parsed in step 404 to determine if the definition(s) contained therein exist in any of the transaction definitions stored in the definition repository 8. If the definition(s) exist, then configuration processor 12 performs step 405 and follows the update transaction definition process discussed later in connection with FIGS. 5A-5B. If configuration processor 12 determines that the schema contains a definition encoded as an attribute in XML, for example, that is not currently stored within any of the stored transaction definitions, configuration processor 12 creates a new transaction definition at step 406. Creation of a new transaction definition may include encoding a new transaction definition in XML or any language readily used by the integration engine 10 and/or creating at least one of a new node, child or grandchild level, attribute or CDATA node within an existing transaction definition in response to the schema encoded by the originating system 20. An individual newly created transaction definition is associated with a specific application on originating system 20 which corresponds to the source of the data. The created transaction definition is mapped to an associated originating application. This mapping provides processing rules for integration engine 10 to process the application data associated with the created transaction definition associated with the originating and destination systems 20, 21. The mapping may be performed automatically or manually depending on the instructions encoded within the schema.

Configuration processor 12 at step 408 determines if the new transaction definition was created successfully. If the transaction definition was created successfully, configuration processor 12 associates the created transaction with the source application at step 410 and generates a status message 40 (FIG. 1) at step 412 that is transmitted to originating system 20 and includes instructions to restart transmission of data objects 30 including application data at step 414. If the transaction definition was not created successfully, configuration processor 12 generates a status message 40 at 416 indicating the need for manual troubleshooting of integration engine 10. Status message 40 generated by configuration processor 12 may be encoded in XML or any other format that preferred by the Destination system 21.

FIGS. 5A and 5B detail the process by which a stored transaction definition is updated in response to a received schema. Originating system 20 (FIG. 1) transmits a schema at step 500 which is received by the input processor 14 (FIG. 1) at step 502. Configuration processor 12 (FIG. 1) parses the schema to determine if definitions encoded as attributes exist in any of the transaction definitions stored in definition repository 18 (FIG. 1). If the definitions do not exist, then configuration processor 12 causes a new transaction definition to be created at step 505 in accordance with the steps discussed in FIG. 4.

If the definition encoded within the schema exists, configuration processor 12 parses the schema for additionally encoded data elements which identify the type of transaction in the transaction definition that is to be updated at step 506. The success of this definition identification is checked at step 508. If the definition cannot be identified for update, configuration processor 12 generates a status message 40 (FIG. 1) encoded in XML or other format required by the Destination system at step 509 indicating failure of the integration engine to identify and/or update the type of transaction definition encoded within the received schema. The status message 40 may include data representing update failure, time and date of attempted update, a unique identifier encoded within the schema and corresponding to the attempted update, and reason for update failure. Status message 40 is used at step 563 in FIG. 5B to alert originating system 20 that, at step 564, manual troubleshooting is required.

If the transaction type within the transaction definition is successfully identified at step 508, configuration processor 12 parses the data elements encoded within the schema to determine if the proposed transaction type update affects the application mapping at step 510. The determination with respect to the affect of any update on the map advantageously determines if the proposed transaction-type update has rendered any maps, tables or other related transaction-type definitions invalid to ensure that future sets of application data are processed correctly. This determination is made at step 520. If the proposed transaction type update does affect the application mapping, configuration processor 12 automatically identifies the impact at step 522 that the proposed transaction type update has on the map in response to the schema and automatically determines if any tables were placed on modified nodes. Configuration processor 12 at step 524 generates a status message 40 indicating that the proposed transaction type update affects the application mapping. This status message includes data representing the portion of the application map affecting including nodes and destinations that are similarly affected by the proposed transaction-type update. For example, if a field is renamed or removed in the updated schema and that field was previously a mapped relation in some map, the message identifies the map that was impacted and how it was impacted (i.e. a required destination value is no longer mapped, for example). Integration engine 10 is also notified if a mapped field is no longer mapped even if it was not a required destination field. Additionally, the status message at step 524 may include data representing the failure of the function, date and time of requested update, a unique identifier created by the originating system encoded in the schema, data representing transaction type update and an impact on other transaction type definitions, and data representing the transaction-type definitions impacted by the update request. Status message 40 is provided at step 563 in FIG. 5B to alert originating system 20 that, at step 564, manual troubleshooting is required.

Referring back to the determination at step 520, if the transaction-type change does not affect the application map, configuration processor 12 parses the schema to determine, in step 530, if an event path table (EPT) flag is set to automatically set the EPT in response to the updated transaction type of the transaction definition. If the EPT flag is not indicated as being set automatically, configuration processor 12 generates a status message 40 at step 532 indicating that the integration engine was successfully updated. The status message continues at step 553 in FIG. 5B which indicates to originating system 20 can restart the queue at step 554 of data objects 30 including application data to be processed by the integration engine in response to the updated transaction definition.

If the EPT flag setting feature is enabled at step 530, the process proceeds at step 535 in FIG. 5B. Referring now to FIG. 5B, the EPT is automatically set at step 540. Configuration processor 12 determines at step 550 whether the EPT was successfully set. If so, the configuration processor generates status message 40 at step 552 indicating successful transaction-type update and setting of the EPT which is transmitted to originating system 20 to alert the originating system to restart the queue of application data to be processed in response to the updated transaction definition at step 554. For example the status message 40 may include data representing the status of the update, date and time of update, and a unique identifier created by the originating system and encoded within the schema to advantageously track any updates. If the EPT was not successfully set, configuration processor 12 identifies the reason for the failure at step 560 and generates a status message 40 including data representing the reason for the failure at step 562. This status message generated at step 562 is provided back to originating system 20 to indicate that manual troubleshooting of the integration engine update functionality is needed (in step 564).

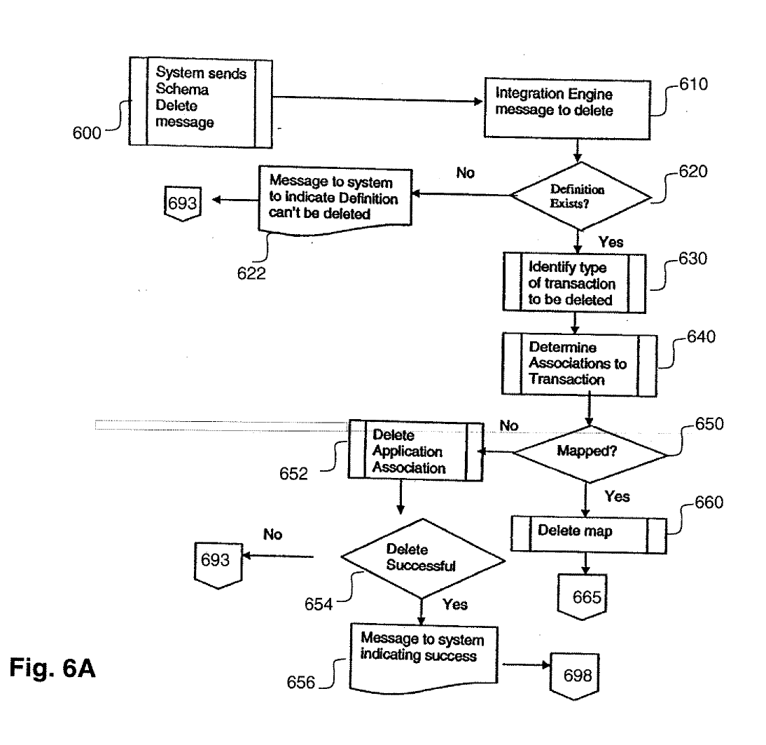

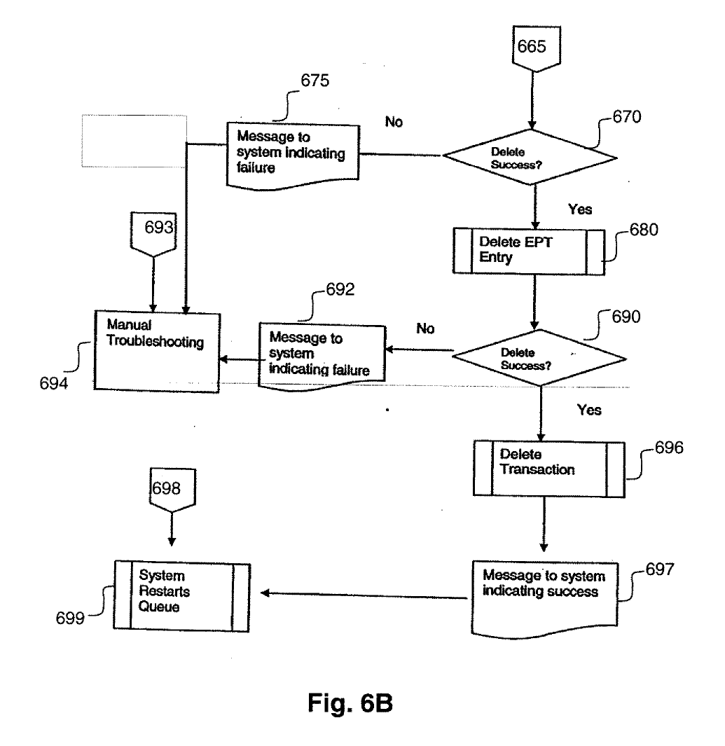

FIG. 6A and 6B detail the process by which a stored transaction definition is deleted in response to a received schema. The delete function performed by the integration engine allows at least one of an entire transaction definition to be deleted or deletes a transaction-type within a transaction definition, or a combination thereof. Originating system 20 (FIG. 1) transmits a schema at step 600 which is received by the input processor 14 (FIG. 1) at step 610. Configuration processor 12 (FIG. 1) parses the schema to determine, at step 620, if the definitions encoded therein as attributes exist in any of the transaction definitions stored in the definition repository 18 (FIG. 1). If the definitions do not exist, configuration processor 12 generates a message at step 622 indicating that the definition cannot be deleted and proceeds at step 693 in FIG. 6B to indicate that manual troubleshooting is necessary (in step 694).

Configuration processor 12 determines the type of transaction definition to be deleted by data encoded within the schema at step 630. Configuration processor 12 further determines and identifies associations of the definition marked for deletion at step 640 and further determines, at step 650, if the marked definition is mapped to a particular source or destination. If the marked definition is not mapped, then the configuration processor causes the application associations of the marked definition within the transaction definition to be deleted at step 652. Configuration processor 12, at step 654, checks the success of the deletion at step 652. If the associates are not successfully deleted, then the process continues at step 693 in FIG. 6B which indicates that manual troubleshooting 694 is required. If the associations are successfully deleted by configuration processor 12, status message 40 indicating this success is generated at step 656 and the process continues at step 698 in FIG. 6B, wherein status message 40 is generated and provided to originating system 20 indicating that the queue of application data transmitted to the integration engine should be restarted at step 699.

Referring back to the determination at step 650 (FIG. 6A) regarding the mapping of a transaction definition marked for deletion, any maps are deleted by configuration processor 12 at step 660. The process continues at step 665 in FIG. 6B and configuration processor 12 determines if the maps were successfully deleted in step 670. If the maps cannot be deleted, a message is generated in step 675 indicating a failure and communicated to originating system 20 indicating that manual troubleshooting in step 694 is necessary.

If the maps of the definition are successfully deleted at step 670, any EPT of the definition is identified and deleted at step 680. Configuration processor 12 determines if the EPT was successfully deleted at step 690. If not successfully deleted, a status message 40 at step 692 is generated indicating system failure and is transmitted to the originating system indicating that manual troubleshooting in step 694 is necessary. If the EPT is successfully deleted, the definition marked for deletion by the received schema is deleted in step 696 from the set of transaction definitions. Configuration processor 12 generates a status message 40 in step 697 indicating that the definition marked for deletion was deleted and originating system 20 is notified to re-start the queue of application data being transmitted to the integration engine in step 699.

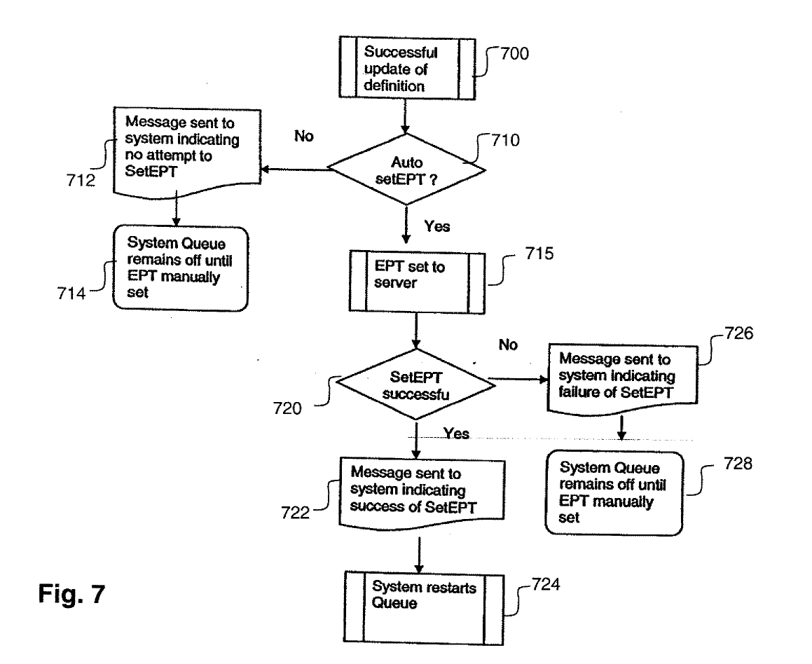

FIG. 7 details the EPT update process discussed above with respect to FIG. 5. The EPT may be updated when a transaction definition has been successfully updated in step 700. The modification of the EPT is an option that is presented by user interface 24 of the originating system. A user at originating system 20 selects whether or not to activate the automatic EPT set function by checking a selection box within a display image provided by user interface 24, for example. This selection (activate or inactive) is encoded within the schema transmitted by originating system 20 to integration engine 10.

Configuration processor 12 parses the schema for an attribute indicating the status of the “setEPT” function at step 710. If the “setEPT” function is manual, then the configuration processor generates status message 40 at step 712 indicating that the configuration processor made no attempt to set the EPT and indicating to originating system 20 that the queue of application data should not be restarted until the EPT is manually set at step 714. If configuration processor 12 determines the “setEPT” functions occurs automatically, the configuration processor sets the EPT in the integration engine at step 715. If it is determined it is successfully set at step 720, a message 40 at step 722 is generated indicating the success and the originating system is notified to re-start the queue at step 724 of application data waiting to be transmitted to integration engine 10. If it is determined the EPT is not automatically set at step 720, a message 40 at step 726 is generated indicating that automatic setting of the EPT failed and originating system 20 is notified that the queue of application data waiting to be transmitted at step 728 to the integration engine should remain off until the EPT is manually set. Status message 40 at step 726 may include data representing the success of the “setEPT” function (value=success or failure), date and time of the attempted operation of the “setEPT” function, a unique identifier encoded by the originating system within the schema, and reason for failure of “setEPT” function (if unsuccessful).

The “setEPt” function is tailored for a corresponding particular transaction-type definition that is to be updated by the schema sent from originating system 20 and the default setting for this feature is “manual” thereby requiring that any updates to the EPT should be made by the user prior to re-starting of the queue of application data.

Referring to FIGS. 3-7, the status messages generated by configuration processor 12 (FIG. 1) indicating the status of the various operations performed and described above may be generated by any processor within the integration engine or by an executable application controlled by a processor of the integration engine. Additionally, while FIGS. 3-7 discuss multiple status messages relating to different system functions, one skilled in the art should realize that a single status message incorporating the status of any of the multiple system functions can be generated and transmitted to originating system 20. An individual status message includes data representing a value that corresponds to the success or failure of specific system functions. The originating system uses these values to determine whether or not the queue of application data waiting to be transmitted to the integration engine should be restarted. This ensures the validity of data exchange and conversion such that any application data is exchanged and converted using the correct transaction definitions.

An example of operation of the system for configuring a data exchange and format conversion system is illustrated in FIGS. 8-10. The following example shows what is configured in the data exchange system and illustrates how a schema is recognized, a piece of a sample schema, and a screen print of the transaction definition the data exchange system creates. The following example should not be taken to limit the scope of the system.

FIG. 8 is a display image provided by user interface 24 used in originating system 20 in FIG. 2. The definition and setup of an Application Definition in a Data exchange system is performed in order for integration engine 10 to know that schemas being transmitted are to be used for creation/update of transaction definitions in the integration engine. If this is not configured, the integration engine parses the received data object and assumes the object to be application data (this is done for backward compatibility so that existing interfaces continue to work). This is something typically set up once in integration engine 10 for each application that sends messages to integration engine 10.

A dialog box 800 provides a tab 802 having multiple user-configurable options for use in generating a schema to at least one of create, update and delete a transaction definition or a transaction-type within a transaction definition. The dialog box 800 includes options to select whether the schema being generated should be used to import the modifications made to the existing definitions via option 824 in integration engine 10 or to use the schema to replace the existing definitions via option 826 in integration engine 10.

The transaction import function 804 provides for importing a transaction into a transaction definition and includes an import tag reference field 806 for specifying the name of the Import Tag that integration engine 10 searches for in order to automatically determine if a message sent from originating system 20 is a schema or is application data. The transaction import function provides for a response by the integration engine 10 to the originating system 20 upon selection of the transaction import option 808. An import response function allows the user to specify the node 810 and tag 812 used in the response as well as select if a response to the source of application data 811 is requested. The source may be selected by operation of a drop-down menu 813 or by manual user input.

The schema generating module further includes an option for replacing a transaction name 814 (update or edit a transaction-type definition). The replace transaction name function includes Tag Reference Field 816 for specifying the data element that will have the value used as the transaction definition name, a Delete Tag Reference Field 818 for specifying the data element to use to determine if a transaction should be deleted, and a Delete Value Field 820 for specifying what value would be in the data element referenced in Field 818 if the transaction should be deleted. For a valid modification including deleting data elements, fields 818 and 820 are used in conjunction with one another.

The schema generating module further includes a selection box 822 for enabling the automatic setting of the EPT in response to the schema generated. Selection of this feature and enables the process described above with respect to FIG. 7.

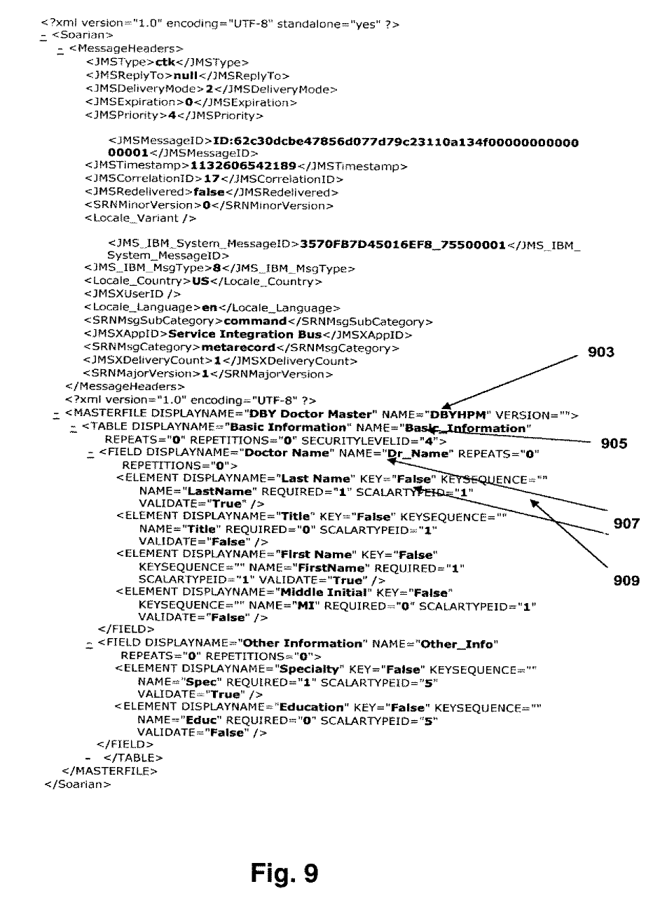

FIG. 9 is an exemplary schema encoded in XML generated in response to the user interface options selected in FIG. 8. The code represents a reduced size version of the type of XML schema sent to integration engine 10 from a particular application. The Import Tag Reference field 806 (FIG. 8) indicates that changes are to be made to the transaction labeled:
<MASTERFILE DISPLAYNAME=“DBY Doctor Master”.

The modification made by configuration processor 12 in response to the schema uses “DBYHMP” 903 as the transaction name to be modified as indicated by
NAME=“DBYHPM“ VERSION=””>

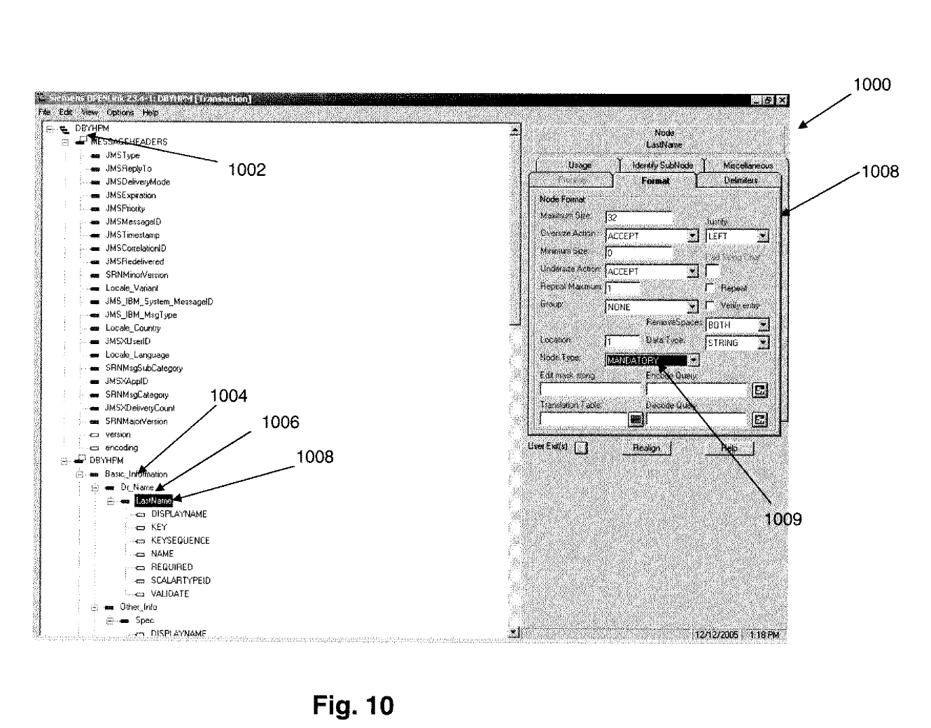

In this transaction, the XML coding specifies the node name and any child nodes that are affected by the modification. If the transaction had not been previously created it imports the entire schema to be used as the transaction definition. The integration engine 10 uses the value specified in 806 (FIG. 8) as the name of the transaction definition. The nodes affected by the modification are “Basic Information” 905 and the children marked “Doctor Name” and “Last Name” 907 need to be modified in the encoded manner. The mandatory modification 909 of the child nodes is represented in FIG. 10 and will be discussed later. The XML schema instructs integration engine 10 to import the entire schema including the MASTERFILE node and include the “Doctor Name” and “Last Name” as well as its children nodes for use as a transaction definition. While a single transaction name is shown as modified, one skilled in the art should be aware that multiple transaction names may be modified as determined by the needs of the applications operated by the originating system or by the users operating the originating system.

FIG. 10 is a display image of a definition created in Data exchange system by the XML schema of FIG. 9. This transaction format may be mapped to any other specified definition using the Data exchange system mapping functionality. A definition window 1000 is shown having treestructured transaction definition 1001. The XML schema of FIG. 9 instructed the transaction definition 1001 to be updated to include the transaction 1002 entitled “DBYHPM”. The updated transaction 1002 includes the node 1004 entitled “Basic Information” having mandatory children 1006 and 1008 entitled “Doctor Name” and “Last name” respectively. Nodes not marked as mandatory are imported and marked as “optional” rather than mandatory in the transaction definition (FIG. 10, 1009). The value 1009 of Mandatory or Optional is used to validate the data received into the integration engine. If marked as Mandatory the node includes a data value in the received application data for it to be accepted. If marked Optional the data shall be accepted whether or not that node is valued. The format for this updated transaction 112 is displayed in format tab area 1008 which controls how data corresponding to the transaction 1002 can be mapped.

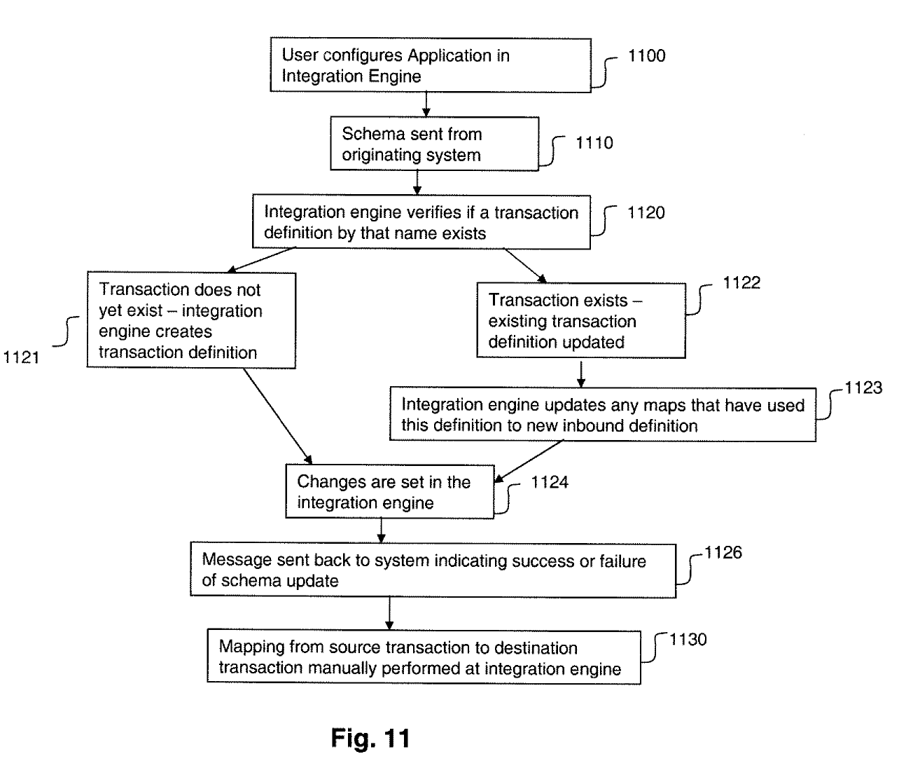

FIG. 11 is a flow diagram detailing the operation of the system. At step 1100, a user at originating system 20 configures the application to create a schema for modifying a transaction definition of an integration engine. Originating system 20 transmits the schema at step 1110 and integration engine 10 verifies if a transaction encoded within the schema exists at step 1120. If the transaction does not exist, then the integration engine creates the transaction definition in response to the XML schema in step 1121. If the transaction definition does exist, the integration engine initiates the transaction definition update process in step 1122. The update process includes at least one of changing, replacing and deleting an existing transaction definition. Upon completion of the update, the integration engine 10 in step 1123 updates any maps that use the updated definition for any future transactions. The integration engine automatically loads and activates the updated transaction definition in step 1124 and generates a status message to be transmitted back to the originating system in step 1126 indicating success or failure of the update. The user at step 1130 may map a source transaction to a destination transaction manually including the EPT of the updated transaction definition.

Although the preferred embodiments for the invention have been described and illustrated, the specific charts and user interfaces are exemplary only. Those having ordinary skill in the field of data processing will appreciate that many specific modifications may be made to the system described herein without departing from the scope of the claimed invention.

What is claimed is:

1. A system for automatically configuring a data exchange system used for exchanging data between different computer systems using different data formats, comprising:
an input processor for receiving an input message having a first data format employed by a particular message source; and
a configuration processor for,
parsing and interpreting said input message to identify characteristics including individual data fields, and
updating stored data conversion information for use in converting data from said particular message source having said first data format to a desired output format used by a target destination system, in response to said identified characteristics.

2. The system according to claim 1, wherein
said input message is encoded in XML and
said data conversion information comprises an XML compatible data definition.

3. The system according to claim 1, wherein
said configuration processor automatically determines said input message is to be used for updating said stored data conversion information based on absence of a data payload being conveyed in said input message.

4. The system according to claim 1, wherein
said configuration processor automatically determines said input message is to be used for updating said stored data conversion information based on absence of a data payload being conveyed in said input message and detection of a flag indicating said input message is to be used as a schema.

5. The system according to claim 4, wherein
said input message is encoded in XML and
said schema comprises an XML compatible data definition.

6. The system according to claim 1, wherein
said configuration processor automatically determines if said data conversion information was updated in response to said identified characteristics, and
automatically generates a status message in response to said determination.

7. The system according to claim 6, wherein
said status message is encoded in XML, and
includes data identifying at least one of (a) time of update, (b) date of update, (c) status of update, and (d) data representing effect of update on additional data fields.

8. The system according to claim 1, wherein
said input message further comprises a unique transaction identifier associated with at least one of said identified characteristics and said data conversion information.

9. The system according to claim 8, wherein
said configuration processor generates a record of said update and associates said generated record with said unique transaction identifier, said record being stored in a transaction modification log.

10. A system for automatically configuring a data exchange system used for exchanging data between different computer systems using different data formats, comprising:
an input processor for receiving an input message having a first data format employed by a particular message source; and
a configuration processor for,
parsing and interpreting said input message to identify characteristics including individual data fields, and
creating stored data conversion information for use in converting data from said particular message source having said first data format to a desired output format used by a target destination system, in response to said identified characteristics.

11. The system according to claim 10, wherein
said configuration processor automatically determines said input message includes executable instruction to be used to update said stored data conversion information replacing existing executable instruction used to update said stored data conversion information.

12. The system according to claim 11, wherein
said configuration processor automatically compares said executable instruction with said existing executable instruction used to update said stored data conversion information.

13. The system according to claim 11, wherein
said configuration processor automatically compares said executable instruction with said existing executable instruction used to update said stored data conversion information and initiates generation of a response message to a source of said input message, said response message indicating mapping definitions affected by replacing said existing executable instruction with said executable instruction received in said input message.

14. The system according to claim 13, wherein
said response message is encoded in XML, and
further includes data identifying at least one of (a) time of deletion, (b) date of deletion, (c) status of deletion, and (d) data representing effect of deletion on additional data fields.

15. The system according to claim 10, wherein
said input message further comprises a unique transaction identifier associated with at least one of said identified characteristics and said data conversion information.

16. The system according to claim 15, wherein
said configuration processor generates a record of said creation and associates said generated record with said unique transaction identifier, said record being stored in a transaction modification log.

17. The system according to claim 11, wherein
said executable instruction comprises a schema.

18. A system for automatically configuring a data exchange system used for exchanging data between different computer systems using different data formats, comprising:
an input processor for receiving an input message having a first data format employed by a particular message source; and
a configuration processor for,
parsing and interpreting said input message to identify characteristics including individual data fields, and
deleting stored data conversion information previously used in converting data from said particular message source having said first data format to a desired output format used by a target destination system, in response to said identified characteristics.

19. The system according to claim 18, wherein
said configuration processor automatically determines if said data conversion information was deleted in response to said identified characteristics, and
automatically generates a status message in response to said determination.

20. The system according to claim 18, wherein
said status message is encoded in XML, and
includes data identifying at least one of (a) time of deletion, (b) date of deletion, (c) status of deletion, and (d) data representing effect of deletion on additional data fields.

21. The system according to claim 18, wherein
said input message further comprises a unique transaction identifier associated with at least one of said identified characteristics and said data conversion information.

22. The system according to claim 21, wherein
said configuration processor generates a record of said deletion and associates said generated record with said unique transaction identifier, said record being stored in a transaction modification log.

23. A method for automatically configuring a data exchange system used for exchanging data between different computer systems using different data formats comprising the activities of:
receiving an input message having a first data format employed by a particular message source;
automatically parsing and interpreting said input message to identify characteristics including individual data fields, and
automatically modifying data conversion information used in converting data from said particular message source having said first data format to a desired output format used by a target destination system, in response to said identified characteristics.

24. The method of claim 23, wherein
said activity of modifying further comprises at least one of (a) creating stored data conversion information in response to said identified characteristics, (b) updating stored data conversion information in response to said identified characteristics, and (c) deleting stored data conversion information in response to said identified characteristics.
